(19) United States
(12) Patent Application Publication
(10) Pub. No.: US 2005/0168315 A1
(43) Pub. Date: Aug. 4, 2005

(54) High capacity fuse and arc resistant end caps therefor

(76) Inventors: Russel Brown, Leicestershire (GB); John William Michael Butters, Loughborough (GB)

Correspondence Address: John S. Beulick;Armstrong Teasdale LLP, Suite 2600, One Metropolitan Square, St. Louis, MI, 63102, US

(21) Appl. No.: 11/041,669

(22) Filed: Jan. 24, 2005

Related U.S. Application Data
(60) Provisional application No. 60/540,408, filed on Jan. 30, 2004.

(51) Int. Cl. H01H 85/165; H01H 85/20; H01H 85/02

(52) U.S. Cl. 337/248

(57) ABSTRACT

A fuse end cap includes an end wall having a bottom surface and a boss extending away from the end wall and defining an exterior cavity in the bottom surface. At least a portion of the boss has a greater thickness than a remainder of the end wall. The end wall resists electrical arcing in a high capacity fuse without the aid of any reinforcing filler material in the cavity.

### CROSS REFERENCE TO RELATED APPLICATIONS

The application claims the benefit of U.S. Provisional application Ser. No. 60/540,408 filed Jan. 30, 2004, the disclosure of which is hereby incorporated by reference in its entirety.

### BACKGROUND OF THE INVENTION

This invention relates generally to fuse, and, more particularly, to arc resistant end caps for miniature cartridge fuses.

Fuses are widely used overcurrent protection devices which are used to open electrical circuits and prevent associated components from damaging current flow through a circuit. Certain types of fuses include an insulative body having conductive end caps coupled to the body at the opposite ends of the body. A fuse element extends through the body and is electrical connected to the end caps such that, when the end caps are coupled to an energized electrical circuit, the circuit is completed through the fuse element. Upon the occurrence of a predetermined current condition flowing through the circuit, the fuse element melts, disintegrates, or otherwise fails, thereby interrupting the current path through the fuse and opening the electrical circuit to isolate load side electrical components and equipment from damaging current.

In England, for example, fuses are often integrated into the plugs of electrical devices. These types of fuses are sometimes referred to as miniature cartridge fuses. U.K. Patent No. 1,474,695 describes one such fuse having cylindrical end caps of a substantially uniform wall thickness. A frusto-conical boss portion is formed on the inside of the respective end wall of each end cap via an impact extrusion process. The formation of the boss portions on the inside of the end wall of each end cap also forms a dimple or cavity in the outside of the end wall of each end cap. For high capacity fuses, the dimple or cavity in the outside of the end caps is filled with solder or metallic filler, thereby strengthening or reinforcing the boss portion from the exterior of the fuse. The additional mass of the filler effectively prevents electrical arcing from penetrating the boss portions of the end caps to the exterior of the fuse when the fuse link opens. Forming the boss portions via impact extrusion and applying the solder or the filler to the exterior cavities or dimples of the ends caps, however, increases assembly time and cost in manufacturing the fuse. Over a large number of fuses, the incremental costs of forming the end caps and applying the filler can be significant.

### BRIEF DESCRIPTION OF THE INVENTION

In an exemplary embodiment, a fuse end cap comprises an end wall comprising a bottom surface and a boss extending away from the end wall and defining an exterior cavity in the bottom surface, at least a portion of the boss having a greater thickness than a remainder of the end wall.

According to another exemplary embodiment, a fuse end cap is provided. The end cap comprises an end wall having a non-uniform wall thickness and comprising a deep drawn boss monolithically formed therewith and forming a discontinuous bottom surface of the end wall. The boss has a different wall thickness than a remainder of the end wall.

According to another exemplary embodiment, a fuse is provided. The fuse comprises an insulative body, and a fuse element extending within the body. First and second end caps are coupled to the body and are electrically connected to the fuse element, and the first and second end caps comprise an end wall and a cylindrical side wall defining an interior receptacle for receiving the fuse body. The end wall comprises a deep drawn boss monolithically formed with the end wall and projecting into the interior receptacle, and the boss defines a cavity in a bottom of the end wall. The boss has a greater wall thickness than a remainder of the end wall to resist electrical arcing when the fuse element opens.

In still another exemplary embodiment, a high capacity cartridge fuse is provided. The fuse comprises a cylindrical body fabricated from a non-conductive material, a fuse element extending within the body, first and second end caps coupled to the body and electrically connected to the fuse element, and conductive washers electrically connecting the fuse element to the first and second end caps. The first and second end caps each consist of deep drawn metal having an end wall and a cylindrical side wall defining an interior receptacle for receiving the fuse body. The end wall comprises a boss monolithically formed with the end wall and projecting into the interior receptacle, and the end wall defining an open exterior cavity in the end wall opposite of the boss. The end wall has a non-uniform wall thickness to resist electrical arcing when the fuse element opens without the aid of a reinforcing filler material in the cavity.

### BRIEF DESCRIPTION OF THE DRAWINGS

FIG. 1 is a cross sectional view of a known fuse.

FIG. 2 is a cross sectional view of a known end cap construction for the fuse shown in FIG. 1.

FIG. 3 is a cross sectional view of another known end cap construction.

FIG. 4 is a cross sectional view of still another known end cap construction.

FIG. 5 is a cross sectional view of an exemplary fuse end cap according to the present invention.

FIG. 6 is a top plan view of the end cap shown in FIG. 5.

FIG. 7 is a cross sectional view of a fuse having end caps as shown in FIGS. 5 and 6.

FIG. 8 is a cross sectional view of another embodiment of a fuse end cap according to the present invention.

FIG. 9 is a cross sectional view of still another embodiment of a fuse end cap according to the present invention.

### DETAILED DESCRIPTION OF THE INVENTION

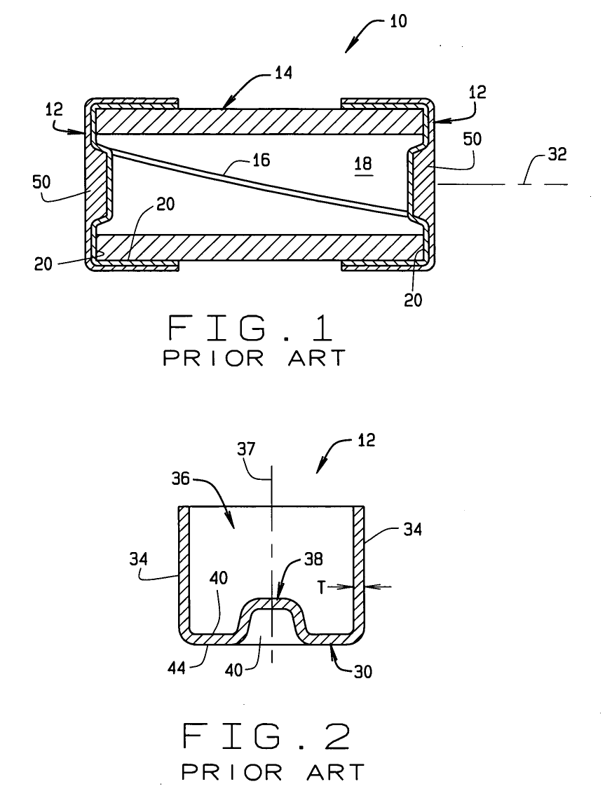

FIG. 1 is a cross sectional view of a known fuse 10 and FIGS. 2 is a cross sectional view of an end cap 12 for the fuse 10. The fuse 10 (FIG. 1) includes an insulative (i.e., nonconductive) tube or body 14 and a fuse element 16 extending within a bore 18 in the body 14. The end caps 12 are coupled to each of the opposite ends of the body 14, and a fuse element 16 is electrically connected to the end caps 12 with inner caps 20 extending between the end caps 12 and the ends of the body 14. The fuse element 16 extends through eyelets in the inner caps 20, and when the inner caps 20 and the end caps 12 are squeezed into intimate contact with one another, the ends of the fuse element 16 are secured between the mating surfaces of the inner caps 20 and the end caps 12. The fuse 10 may be recognized as a high capacity, miniature cartridge fuse, and is more completely described in U.K. Patent No. 1,474,695. As used herein “high capacity” refers to high breaking capacity as defined in standards of the International Electrotechnical Commission (IEC), such as for example, IEC 127 fuses having a maximum breaking capacity of up to 1500 amps.

Referring to FIG. 2, the end caps 12 are formed with an end wall 30 which extends substantially perpendicular to a longitudinal axis 32 (FIG. 1) of the fuse body 14 when the fuse 10 is assembled. A side wall 34 extends from the end wall 20 in a substantially perpendicular fashion and extends cylindrically from the end wall 32 to define an interior receptacle 36 above the end wall 30. The receptacle 36 extends along an axis 37 which aligns with the longitudinal axis 32 of the fuse body 14 when the receptacle 36 is fitted over the ends of the fuse body 14 as shown in FIG. 1. A frusto-conical boss portion 38 is formed, via impact extrusion, into an inner surface 40 of the end wall 30, and the boss portion 38 projects inward into the interior receptacle 36 of the end cap 12 and away from the end wall 30. The formation of the boss portion 38 in the end wall 30 also produces a recessed dimple or cavity 40 on an exterior surface 44 of the end wall 30 of each end cap 12. The end wall 30, the side wall 34, and the boss portion 38 have a substantially uniform wall thickness T.

For high capacity fuses, and as shown in FIG. 1, the dimples or exterior cavities 40 in the end caps 12 are filled with solder or metallic filler 50, thereby strengthening or reinforcing the boss portion 38 from the exterior of the end caps 12. When the fuse element 16 opens, the additional mass of the filler 50 effectively prevents electrical arcing from penetrating the boss portions 38 of the end caps 12. While the fuse 10 is reliably constructed, applying the solder or the filler 50 to the end caps 12 undesirably complicates manufacturing of the fuse 10 and increases associated costs.

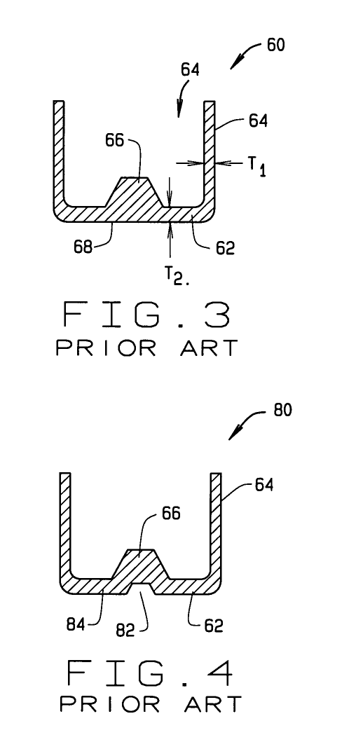

FIG. 3 illustrates another known construction of a fuse end cap 60 including an end wall 62 and a side wall 64 defining an interior receptacle 62 which may be fitted over an end of fuse body, such as the body 14 shown in FIG. 1. A raised boss portion 66 is formed in the bottom wall 62 and extends upward therefrom into the interior receptacle 64 of the end cap 60. Unlike the end cap 12, the end cap 60 does not have a uniform wall thickness, but rather has a relatively thin wall construction of a thickness T₁ in the side wall 64, and a greater wall thickness T₂ in the end wall 62 on either side of the central boss portion 66. Also, unlike the end cap 12, the end wall 62 does not include an exterior dimple or cavity in the end wall, but rather the end wall 62 has a substantially continuous outer surface 68.

The end cap 60 is formed in an impact extrusion process and may be used with a high capacity, miniature cartridge fuse as described in, for example, U.K. Patent No. 1,167,583. The thicker end wall construction and the raised boss 66 provide sufficient structural strength to withstand opening of a high capacity fuse element, but is believed to be disadvantaged in that it uses an undue amount of material and is not efficient from a manufacturing perspective.

FIG. 4 illustrate a known construction of a fuse end cap 80 similar to the end cap 60 (shown in FIG. 3) except that an exterior cavity or dimple 82 is formed in the end wall 62 and is exposed from the bottom surface 84 of the end wall 62 thereby creating a discontinuity in the bottom surface 84. The cavity or dimple 82 is also formed with an impact extrusion process to reduce the amount of material in the end wall 62. Inpact extrusion processes, however, entails an undesirable amount of time in the manufacturing process to form the end cap 80.

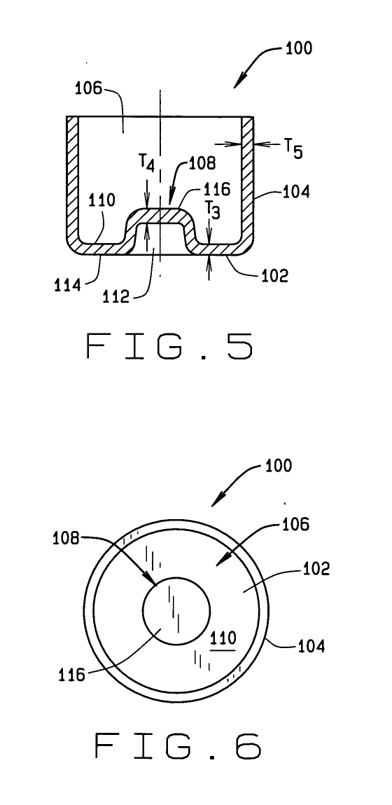

FIGS. 5 and 6 are a cross sectional view and a top plan view, respectively, of an exemplary fuse end cap 100 formed in accordance with the present invention and which facilitates a more economical fuse manufacture than the end caps 12, 60 or 80 (shown in FIGS. 1-4). While described in the context of high capacity, miniature cartridge fuses, it is contemplated that the benefits of the invention may apply to other types of fuses, and the invention is not intended to be limited in application to any particular type of fuse.

Unlike the foregoing end cap 12 (shown in FIGS. 1 and 2), the end cap 60 (shown in FIG. 3) and the end cap 80 (shown in FIG. 4), the end cap 100 may be formed via a deep drawn metal process, which is a more efficient manufacturing process than impact extrusion, and without applying filler material 50 (shown in FIG. 1) to the end caps to resist electrical arcing associated with opening of a fuse element. Thus, the end caps 100 may be formed more quickly using reduced amounts of material, and more fuses may be manufactured at lower cost by eliminating filler material to reinforce the end cap 100 for use with high capacity fuses.

In an exemplary embodiment, the end cap 100 is formed in a deep drawn metal process with an end wall 102 and a side wall 104 extending from the end wall 102 in a substantially perpendicular fashion. The side wall 104 extends cylindrically from the end wall 102 to define an interior receptacle 106. A frustoconical boss portion 108 is formed into an inner surface 110 of the end wall 102, and the boss portion 108 projects inward into the interior receptacle 106. The formation of the boss portion 108 in the end wall 102 also produces a recessed dimple or cavity 112 in an exterior surface 114 of the end wall 102 of the end cap 100.

The end cap 100 does not have a uniform wall thickness, but rather apportions the wall thickness optimally to the appropriate areas of the end cap 100. For example, the end wall 102 has a non-uniform thickness wherein the portion of the end wall surrounding the boss portion 108 has a first thickness T₃, and a central portion 116 of the boss 108 has a second thickness T₄ that is greater than T₃. Thus, a thicker, reinforced boss 108 is formed which extends interior to the end cap 106 and away from the end wall 102. The side wall 104 has a thickness T₅ which is approximately the same as the end wall thickness T₃ in one embodiment.

In an exemplary embodiment, the end cap 100 is fabricated from a conductive material, including but not limited to sheet metal, according to a known deep drawn metal technique familiar to those in the art. The boss portion 108, including its increased thickness T₂ is monolithically formed into the end cap structure in one exemplary embodiment. With a deep drawn monolithic structure of a single material, the end cap 100, and especially the boss portion 108 is structurally stronger than, for example, the end caps 12 (shown in FIG. 1 and 2) having a uniform wall construction and a filler material 50 (shown in FIG. 1). The ultimate thickness T₄ of the boss portion 108 of the end cap 100 is generally less than the combined thickness T of the end cap 12 (FIG. 2) and the thickness of the filler material 50 (FIG. 1) which would otherwise be used, thereby providing material savings in the fabrication of the end cap 100. Further, the increased strength of the end cap 100 renders the filler material 50 unnecessary, thereby reducing manufacturing time and costs associated with applying the filler 50.

Further, the end cap 100 uses a reduced amount of material in comparison to the end cap 60 (shown in FIG. 3) which employs a solid boss portion 66 as opposed to the hollow boss portion 108 of the end cap 100. Additionally, the end caps 100 may be formed more quickly via deep drawn metal processes than the end caps 60 (FIG. 3) formed by impact extrusion. Similarly, the deep drawn end caps 100 may be formed more quickly than the impact extruded end caps 80 (FIG. 4) with more consistent control over the relative wall thickness of the different portions of the cap 100.

A unitary or integral, monolithic construction of an end cap 100 is therefore provided with a non-uniform wall construction which capably resists electrical arcing without the need for external filler material 50 (shown in FIG. 1) and with a reduced amount of material to fabricate the end cap. Manufacturing costs and time associated applying the filler 50 may therefore be saved, and deep drawn metal techniques reduces the time needed to form the end caps 100 in the manufacture of fuses. Fuses may therefore be manufactured in less time and at a lower cost than fuses having any of the foregoing known types of end caps 12, 60 and 80.

The relative values of thicknesses T₃, T₄ and T₅ may be selected for a given fuse capacity as those in the art will appreciate. By way of example, in one embodiment T₃ is 0.3 mm and T₄ is 0.45 mm in a high capacity fuse which conforms to British Standard 1362 for cartridge fuses. Other values may be employed as appropriate to meet specific objectives.

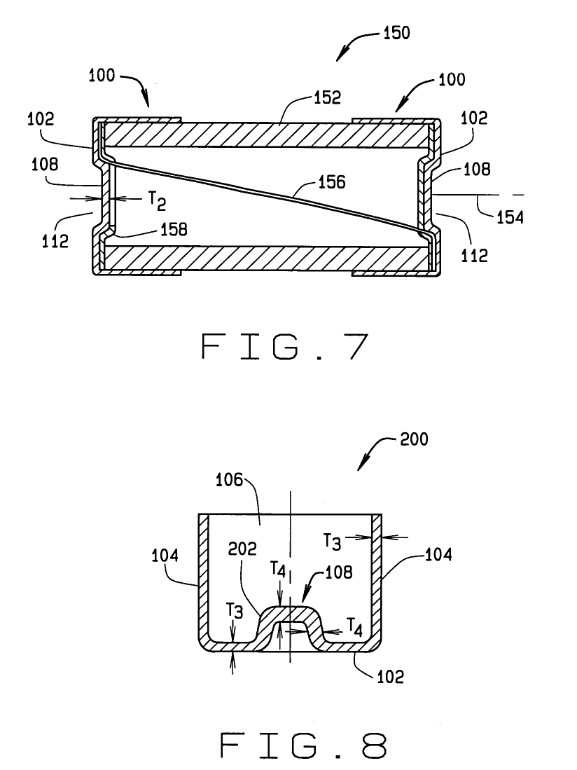

FIG. 7 is a cross sectional view of a fuse 150 including the end caps 100. The interior receptacle 106 (FIG. 5) is fitted over the ends of a fuse body 152, and the end caps are coupled to the fuse body 152 whereby the end walls 102 of the end caps 100 extend substantially perpendicular to a longitudinal axis 154 of the fuse body 152.

A fuse element 156 is electrically connected to the end caps 100 in a known manner, such as via conductive washers 158 extending between the end caps 100 and the ends of the body 152. The fuse element 156 extends through eyelets in the washers 158, and when the washers 158 and the end caps 100 are squeezed into intimate contact with one another, the ends of the fuse element 156 are secured between the mating surfaces of the washers 158 and the end caps 100. The external cavities 112 of the end caps 100 are exposed to the exterior of the fuse 150, and because of the thicker wall section T₄ in the boss portion 108, any filler material 50 (shown in FIG. 1) is unnecessary and omitted from the fuse construction.

FIG. 8 is a cross sectional view of another embodiment of a fuse end cap 200 similar to the end caps 100 (shown in FIGS. 5-7) and in which like features of the end caps 100 and the end cap 200 are indicated with like reference numerals. Unlike the end caps 100, the boss portion 108 has a thickness T₄ not only in the raised area of the boss portion 108 which extends parallel to the end wall 102, but also in the transition areas 202 of the boss portion 108 which extend from the end wall 102 to the raised area of the boss 108. The remainder of the end cap 200 has a wall thickness of T₃. The end cap 200 is therefore strengthened with a thickness T₄ on all the interior surfaces of the boss portion 108 for even higher capacity fuses than fuse 150 having the end caps 100. The end cap 200, like the end cap 100, eliminates the filler material 50 (shown in FIG. 1) which would otherwise be required to address electrical arcing issues when a fuse element opens in use, and may be formed in a more time efficient manner with deep drawing techniques using reduced amounts of material. End caps 200 may be substituted for the end caps 100 in a fuse, such as fuse 150 (shown in FIG. 4).

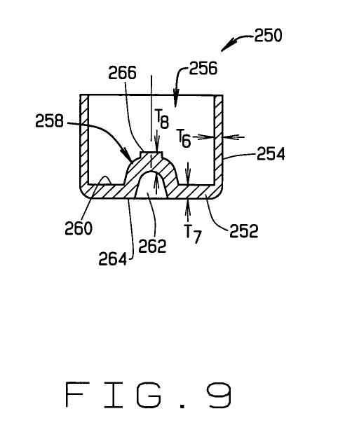

FIG. 9 illustrates another embodiment of a deep drawn end cap 250 in accordance with the present invention. Like the end cap 100, the end cap 250 includes an end wall 252 and a side wall 254 extending from the end wall 252 in a substantially perpendicular fashion. The side wall 254 extends cylindrically from the end wall 252 to define an interior receptacle 256. A frusto-conical boss portion 258 is formed into an inner surface 260 of the end wall 252, and the boss portion 258 projects inward into the interior receptacle 256. The formation of the boss portion 258 in the end wall 252 also produces a recessed dimple or cavity 262 in an exterior surface 264 of the end wall 252.

The end cap 250 does not have a uniform wall thickness, but rather apportions the wall thickness optimally to the appropriate areas of the end cap 250. For example, the end wall 252 has a non-uniform thickness wherein the side wall has a first thickness T₆, a portion of the end wall 252 surrounding the boss portion 258 has a second thickness T₇ which is greater than T₆, and a central portion of the boss 258 has a third thickness T₈ that is greater than T₇. Thus, a thicker, reinforced boss 258 is formed which extends interior to the end cap 250 and away from the end wall 252.

The side wall 254 has a comparatively thinner thickness which abuts the outer surface of a fuse body, which provides for material savings compared to, for example, the end cap 100 shown in FIG. 5 in which the end wall 112 and the side wall 114 have an approximately equal thickness. Further, square (i.e., perpendicular) corners 266 are provided in the boss portion 266 which provide for material savings over a large amount of end caps 250 in the manufacturing process.

While the invention has been described in terms of various specific embodiments, those skilled in the art will recognize that the invention can be practiced with modification within the spirit and scope of the claims.

1. A fuse end cap comprising:
an end wall comprising a bottom surface and a boss extending away from said end wall and defining an exterior cavity in said bottom surface, at least a portion of said boss having a greater thickness than a remainder of said end wall.

2. A fuse end cap in accordance with claim 1 further comprising a side wall extending from said end wall and defining an interior receptacle, said boss projecting into said interior receptacle.

3. A fuse end cap in accordance with claim 2 wherein said side wall is cylindrical.

4. A fuse end cap in accordance with claim 1 wherein said boss is monolithically formed with said end wall.

5. A fuse end cap in accordance with claim 1 wherein said boss comprises a top segment and a transition segment extending from said wall, said top segment having a greater thickness than said transition segment.

6. A fuse end cap in accordance with claim 1 wherein said boss comprises a top segment and a transition segment, said top segment and said transition segment having a substantially equal thickness.

7. A fuse end cap in accordance with claim 1 wherein said end cap comprises a side wall having a first thickness, said end wall having a second thickness greater than said first thickness.

8. A fuse end cap in accordance with claim 1 wherein said end cap comprises deep drawn metal.

9. A fuse end cap comprising:
an end wall having a non-uniform wall thickness and comprising a deep drawn boss monolithically formed therewith and forming a discontinuous bottom surface of said end wall, said boss having a different wall thickness than a remainder of said end wall.

10. A fuse end cap in accordance with claim 9 wherein said boss has a greater wall thickness than a remainder of said end wall.

11. A fuse end cap in accordance with claim 9 further comprising a deep drawn side wall monolithically extending from said end wall and defining an interior receptacle.

12. A fuse end cap in accordance with claim 11 wherein said boss projects into said interior receptacle.

13. A fuse end cap in accordance with claim 11 wherein said side wall is cylindrical.

14. A fuse end cap in accordance with claim 9 wherein said boss portion comprises a top segment and a transition segment, said top segment having a greater thickness than said transition segment.

15. A fuse end cap in accordance with claim 9 wherein said boss comprises a top segment and a transition segment, said top segment and said transition segment having a substantially equal thickness.

16. A fuse end cap in accordance with claim 9 wherein said discontinuous bottom surface comprises an outer surface and a recessed cavity.

17. A fuse comprising:
an insulative body;
a fuse element extending within said body; and
first and second end caps coupled to said body and electrically connected to said fuse element, said first and second end caps comprising an end wall and a cylindrical side wall defining an interior receptacle for receiving said fuse body, said end wall comprising a deep drawn boss monolithically formed with said end wall and projecting into said interior receptacle, said boss defining a cavity in a bottom of said end wall, and said boss having a greater wall thickness than a remainder of said end wall to resist electrical arcing when said fuse element opens.

18. A fuse in accordance with claim 17 wherein said boss is frusto-conical.

19. A fuse in accordance with claim 17 wherein said boss is centrally located on said end wall.

20. A high capacity cartridge fuse comprising:
a cylindrical body fabricated from a non-conductive material;
a fuse element extending within said body;
first and second end caps coupled to said body and electrically connected to said fuse element; and
conductive washers electrically connecting the fuse element to said first and second end caps;
wherein said first and second end caps each consist of deep drawn metal having an end wall and a cylindrical side wall defining an interior receptacle for receiving said fuse body, said end wall comprising a boss monolithically formed with said end wall and projecting into said interior receptacle, and said end wall defining an open exterior cavity in said end wall opposite of said boss, said end wall having a non-uniform wall thickness to resist electrical arcing when said fuse element opens without the aid of a reinforcing filler material in said cavity.
